(19) United States
(12) Patent Application Publication
(10) Pub. No.: US 2026/0175766 A1
(43) Pub. Date: Jun. 25, 2026

(54) TRANSPORTER

(71) Applicant: Vestas Wind Systems A/S, Aarhus N. (DK)

(72) Inventors: Kurt Jensen, Aarhus N (DK); Denys Kotushenko, Aarhus N (DK); Dan Mølgaard Mathiasen, Hinnerup (DK)

(73) Assignee: Vestas Wind Systems A/S, Aarhus N. (DK)

(21) Appl. No.: 19/124,908

(22) PCT Filed: Nov. 7, 2023
(86) PCT No.: PCT/DK2023/050271

§ 371 Date: Apr. 28, 2025

(30) Foreign Application Priority Data
Nov. 15, 2022 (DK) PA202270554

(51) Int. Cl. B60P 3/077; B60P 3/40; B62B 3/02; F03D 1/06

(52) U.S. Cl. CPC B60P 3/077; B60P 3/40; B62B 3/02; F03D 1/0675

(57) ABSTRACT

The present disclosure relates to a transporter for supporting the tip end of a wind turbine blade which is configured to account for bending and torsional stresses which may be applied to the blade during transportation by allowing for rotation of the turbine blade about a first and second horizontal axis.

### FIELD

The present invention relates to a transporter for supporting a tip end of a wind turbine blade.

### BACKGROUND

As the global demand for clean energy continues to increase, so does the demand for larger capacity wind turbines capable of meeting this demand. However, high capacity (>3 MW) wind turbines require very large rotor diameters to allow the wind turbines to sweep greater areas and hence produce larger amounts of electricity. As such, the span lengths of the turbine blades which make up modern wind turbine rotors are also very large which can make transporting modern wind turbine blades a significant challenge.

In particular, due to their significant length, modern turbine blades are often exposed to significant bending or torsion stresses during transportation (for example when cornering or navigating across banked or inclined roadways) which have the potential to damage the composite material of the blades. As such, it is an aim of the present invention to provide a means for reducing the bending and/or torsional stresses exerted on a given wind turbine blade during transportation.

### SUMMARY

According to a first aspect of the present disclosure, there is provided a ground transporter for supporting a tip end of a wind turbine blade, the transporter comprising:
a chassis having at least one ground contacting element;
a clamping arrangement configured for securing a tip end of a wind turbine blade to the chassis; and
an adjusting mechanism configured to permit movement of the clamping arrangement relative to the chassis,
wherein the adjusting mechanism is configured to allow the clamping arrangement to rotate about at least one horizontal axis.

Advantageously, the provision of an adjusting mechanism configured to permit movement of the clamping arrangement about a first and/or second horizontal axis allows the transporter to better account for bending or torsional loads which may be generated during transportation, and hence helps to prevent such loads from being applied onto the turbine blade.

In some examples, the clamping arrangement may be rotatably mounted to the chassis to allow the clamping arrangement to rotate about a vertical (Z) axis relative to the chassis.

In some examples, the clamping arrangement may be mounted to the chassis via a rotational table.

In some examples, the adjusting mechanism may be pivotably connected to the clamping arrangement so as to permit rotation of the clamping arrangement about the first and/or horizontal axis.

In some examples, the adjusting mechanism may be pivotably connected to the clamping arrangement via at least one ball joint linkage.

In some examples, the adjusting mechanism may comprise a first linear actuator configured for adjusting a height of a first portion of the clamping arrangement relative to the chassis.

In some examples, the first linear actuator may be orientated at an angle less than 45 degrees to the horizontal.

Advantageously, the provision of a linear actuator oriented at an angle of less than 45 degrees to the horizontal better allows the adjusting mechanism to make fine-level adjustments to the height of the clamping arrangement.

In some examples, the adjusting mechanism may comprise a first pair of legs which are pivotably connected to the clamping arrangement.

In some examples, the first linear actuator may be arranged between the first pair of legs.

In some examples, the adjusting mechanism may comprise a second linear actuator configured for adjusting a height of a second portion of the clamping arrangement relative to the chassis.

In some examples, the second linear actuator may be orientated at an angle less than 45 degrees to the horizontal.

Advantageously, the provision of a linear actuator oriented at an angle of less than 45 degrees to the horizontal better allows the adjusting mechanism to make fine adjustments to account for slopes and cambers along a roadway during transportation, thereby helping to prevent the associated bending or torsional loads from being applied onto the turbine blade.

In some examples, the adjusting mechanism may comprise a second pair of legs which are pivotably connected to the clamping arrangement.

In some examples, the second linear actuator may be arranged between the second pair of legs.

In some examples, the first and second linear actuators may comprise hydraulic cylinders.

In some examples, the first and second hydraulic cylinders may be connected in fluid communication with each other.

In some examples, the first and/or second pair of legs may be configured to engage with a corresponding guideway.

In some examples, the guideway may be oriented along a longitudinal axis of the chassis so as to permit translation of first and/or second pair of legs along a length of the chassis.

In some examples, the guideway may be oriented along a transverse axis of the chassis so as to permit translation of the first and/or second pair of legs across a width of the chassis.

In some examples, the adjusting mechanism may be configured to allow the clamping arrangement to rotate about a first horizontal axis and a second horizontal axis relative to the chassis.

In some examples, the second horizontal axis may be perpendicular to the first horizontal axis.

In some examples, the adjusting mechanism may comprise a swing frame configured to permit rotation of the clamping arrangement about the first or second horizontal axis.

In some examples, the adjusting mechanism may be actively controlled.

In some examples, the adjusting mechanism may comprise a plurality of linear actuators configured to permit vertical translation of the clamping arrangement relative to the chassis and configured to permit rotation of the clamping arrangement about the first and second horizontal axes relative to the chassis. In some examples, the adjusting mechanism may comprise a hexapod of linear actuators.

In some examples, each of the linear actuators may be orientated at an angle less than 45 degrees to the horizontal.

In some examples, the adjusting mechanism may be actively controlled.

In some examples, the clamping arrangement may be configured to engage the wind turbine blade across a chordwise portion of the wind turbine blade.

In some examples, the clamping arrangement may comprise a clam-shell arrangement having an upper portion, a lower portion and a hinge connecting the upper and lower portions so as to allow the upper portion to pivot relative to the lower portion between an open and a closed position.

In some examples, the transporter may be a dolly trailer.

In some examples, the clamping arrangement may be fixed to the chassis to substantially prevent translation of the clamping arrangement along a horizontal plane of the chassis.

In some examples, the transporter may be an extendable trailer.

In some examples, the clamping arrangement may be slidably mounted to the chassis, optionally via one or more guideways, to permit translation of the clamping arrangement along a horizontal plane of the chassis.

Advantageously, the provision of a clamping arrangement which is slidably mounted to the chassis allows the centre of gravity of the clamping arrangement to shift as it tilts/rolls which helps to maintain more even loading on the transporter as the turbine blade rotates.

In some examples, the clamping arrangement may be slidably mounted to the chassis, optionally via one or more guideways, to permit translation of the clamping arrangement along a length of the chassis.

### BRIEF DESCRIPTION OF THE DRAWINGS

Examples will now be described with reference to the accompanying drawings, in which:

FIG. 1 illustrates a front view of a wind turbine;

FIG. 2 illustrates a perspective view of a transporter according to one example of the claimed invention, wherein the transporter is a dolly trailer;

FIG. 3 illustrates a perspective view of a transporter according to another example of the claimed invention, wherein the transporter is an extendable trailer;

FIG. 4 illustrates a perspective view of a clamping arrangement for securing the tip end of a wind turbine blade to suitable transporter, such as those illustrated in FIGS. 2 and 3;

FIG. 5 illustrates a perspective view of an adjusting mechanism according to an example of the claimed invention suitable for mounting a clamping arrangement (such as the one illustrated in FIG. 4) to a transporter (such as those illustrated in FIGS. 2 and 3);

FIG. 6 illustrates a perspective view of an adjusting mechanism according to another example of the claimed invention; and

FIG. 7 illustrates a perspective view of a further adjusting mechanism according to yet another example of the claimed invention.

### DETAILED DESCRIPTION

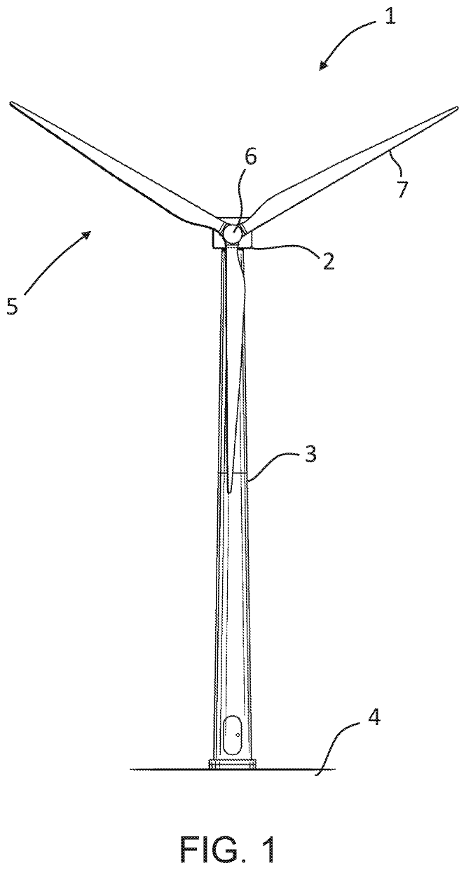

FIG. 1 shows a wind turbine 1 including a nacelle 2 supported on a tower 3 that is mounted on a foundation 4. The wind turbine 1 depicted here is an onshore wind turbine such that the foundation 4 is embedded in the ground, but the wind turbine 1 could be an offshore installation in which case the foundation 4 would be provided by a suitable marine platform, such as a monopile or jacket.

The nacelle 2 supports a rotor 5 comprising a hub 6 to which three blades 7 are attached. The blades 7 which make up the rotor 5 of the wind turbine 1 each comprise a tip end, which is located distal from the hub 6, and a root end, which is located proximal to the hub 6. It will be noted that the wind turbine 1 is the common type of horizontal axis wind turbine (HAWT) such that the rotor 5 is mounted at the nacelle 2 to rotate about a substantially horizontal axis defined at the centre at the hub 6. As is known, the blades 7 are acted on by the wind which causes the rotor 5 to rotate about its axis thereby operating generating equipment through a gearbox (not shown) that is housed in the nacelle 2. The generating equipment is not shown in FIG. 1 since it is not central to the examples of the invention.

Wind turbine blades, such as those which are displayed in FIG. 1, are typically manufactured from glass or carbon fibre reinforced composite materials and hence can be prone to damage due to bending or torsional forces, particularly when such forces are applied in a direction which is perpendicular to the orientation of the fibre reinforcements within the blade. One of the most common scenarios in which bending or torsional forces may be applied to a wind turbine blade is during transportation. For example, when cornering or travelling over hilly terrain, there can be a significant difference between the horizontal or vertical position of the root end of the turbine blade relative to the tip end of the turbine blade which can potentially lead to bending stresses being applied to the blade. Similarly, when travelling over banked terrain, there can be a significant difference between the orientation of the root end of the turbine blade relative to the tip end of the turbine blade, which can potentially lead to torsional (or twisting) forces being applied to the blade.

The present disclosure relates to a ground transporter for supporting a tip end of a wind turbine blade.

The term “ground transporter” is used herein to describe a vehicle or trailer which can be used to transport a wind turbine over solid ground, such as along a roadway or railway line.

In some examples, the ground transporter may be provided in the form of a dolly trailer (or road dolly) for use with a road vehicle. In other examples, the transporter may be rail trailer (or rail dolly) for use with a locomotive or another form of rail vehicle. Furthermore, in some examples, the transporter may be an extendable trailer or a self-propelled modular transporter (SPMT). It shall also be appreciated that in some examples, the transporter may be a vehicle, such as a road vehicle (e.g., a flatbed truck) or a rail vehicle (e.g., a locomotive or other form of rolling stock).

In the illustrated examples, a first horizontal axis (X) is defined which extends in a direction which is parallel to a longitudinal axis of the transporter, and hence extends along a length of the transporter. A second horizontal (Y) axis is also defined which extends in a direction which is parallel to a transverse axis of the transporter, and hence extends across a width of the transporter, perpendicular to the longitudinal axis. However, it shall be appreciated that in some examples, the first and second horizontal axis may have different orientations. In some examples, the first horizontal axis may be defined as an axis which is parallel to a transverse axis of the transporter and the second horizontal axis may be defined as an axis which is parallel to a longitudinal axis of the transporter. It shall also be appreciated that in some examples, the angle formed between the first and second horizontal axes may be more than 90 degrees or less than 90 degrees.

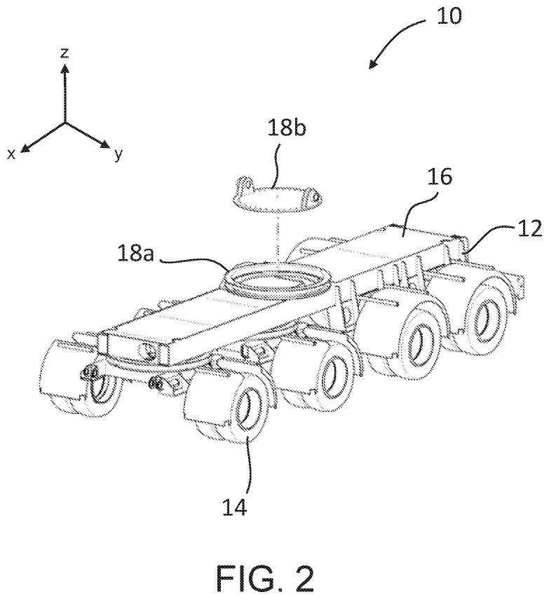

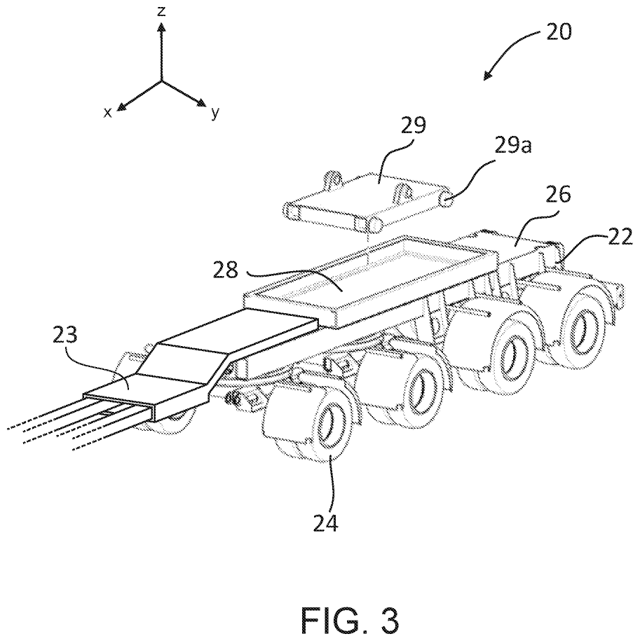

Examples of suitable transporters which may be used for supporting the tip end of a wind turbine blade during transportation are shown in FIGS. 2 and 3.

FIG. 2 illustrates an example transporter wherein the transporter is provided as a dolly trailer 10. The dolly trailer 10 includes a chassis 12 which may be supported on a plurality of wheels 14 disposed on either side of the chassis 12 along the chassis'length. However, it shall be appreciated that in some examples, the transporter may comprise a different form of ground contacting element such as a crawler track.

The chassis 12 comprises a substantially flat upper surface 16 to which a clamping arrangement may be mounted, as shall be described in greater detail at a later stage within this application. When in use, the clamping arrangement is used to secure a tip end of a wind turbine blade to the transporter. “Dollies” or “dolly trailers” are a category of trailer wherein the trailer (or dolly) is not directly attached to a pulling vehicle (e.g., a motor vehicle or rail vehicle). As such, when using a dolly, all the traction provided by the pulling vehicle is applied to the dolly via the turbine blade. In other words, when mounted on a dolly, the blade itself essentially acts as the connector which connects the dolly to the pulling vehicle. As such, significant bending stresses can be generated in the blade during transportation, particularly when cornering.

In the example illustrated in FIG. 2, the clamping arrangement is rotatably mounted to the chassis 12 to allow the clamping arrangement to rotate about a substantially vertical (Z) axis relative to the chassis. Advantageously, allowing the clamping arrangement to rotate about a substantially vertical axis relative to the chassis helps counteract the bending stresses which may be generated during cornering.

In the illustrated example, the vertical (Z) axis is oriented perpendicular to the first (X) and second (Y) horizontal axes of the transporter. However, it shall be appreciated that in other examples, the angle formed between the vertical axis and the first and second horizontal axes may be more than 90 degrees or less than 90 degrees.

A rotatable mount may be provided to rotatably mount the clamping arrangement to the chassis. The rotatable mount may be configured to permit approximately 360-degree rotation of the clamping arrangement relative to the chassis, although in some examples the degree of rotation permitted by the rotatable mount may be less than 360 degrees.

The rotatable mount, and hence the clamping arrangement, which is secured thereto, may be fixed to the chassis such that translation of the clamping arrangement along the horizontal plane defined by the upper surface of the chassis is substantially prevented. Advantageously, fixing the clamping arrangement relative to the chassis helps to prevent “lag” between movement of the pulling vehicle and movement of the transporter when the transporter is provided in the form of a dolly trailer. However, in other examples, it shall be appreciated that the rotatable mount may be secured to the chassis via a guideway, track or other suitable arrangement which permits translation of the rotatable mount along the first and/or second horizontal axes of the transporter.

In the example illustrated in FIG. 2, the rotatable mount is provided in the form of a rotational table 18. The rotational table 18 comprises a fixed portion 18a which may be fixed to an upper surface 16 of the transporter, such that translation of the rotational table relative to the chassis 12 is substantially prevented, and a rotary part 18b which may be rotatably mounted to the fixed part 18a.

The rotatable mount may be secured to the upper surface of the transporter approximately mid-way along the length of the chassis. For example, as is illustrated in FIG. 2, the fixed portion 18a of the rotational table 18 is secured to the upper surface 16 of the trailer 10 approximately mid-way along the length of the chassis 12. However, it shall be appreciated that in some examples, the rotatable mount may be provided at other positions along the chassis'length.

Meanwhile, FIG. 3 illustrates an example transporter wherein the transporter is provided as an extendable trailer 20. As with the dolly trailer 10 illustrated in FIG. 2, the extendable trailer 20 illustrated in FIG. 3 also includes a chassis 22 which may be supported on a plurality of wheels 24 disposed on either side of the chassis 22 along the chassis'length. However, as with FIG. 2, it shall be appreciated that in some examples, the transporter may comprise a different form of ground contacting element such as a crawler track or other suitable ground contacting element.

The chassis 22 also comprises a substantially flat upper surface 26 to which a clamping arrangement may be mounted when in use for securing a tip end of a wind turbine blade to the transporter. A connecting element 23 (e.g., a connecting beam) may also be provided at the front end of the chassis 22 for connecting the rear end of the extendable trailer (shown in FIG. 3), which is configured to receive the tip end of the turbine blade, to a front end of the extendable trailer (not shown), which typically supports the root end of the turbine blade.

“Extendable trailers” are a different category of trailer to dolly trailers. Notably, “Extendable trailers” do not use the turbine blade as the primary connector between the pulling vehicle and the trailer. In other words, when using an extendable trailer, the traction force provided by the pulling vehicle is not applied directly through the blade. As such, when transporting a blade using an extendable trailer, the blade is not typically exposed to the same magnitude of bending stress. However, when using an extendable trailer, it is often desirable to allow for translation of the blade to help account for compressive and tensile stresses which may be applied to the blade during acceleration or deceleration of the transporter and to allow the centre of gravity of the clamping arrangement to be shifted during transport to maintain more even loading on the transporter.

The clamping arrangement may therefore be slidably mounted to the chassis to permit translation of the clamping arrangement along a horizontal plane defined by an upper surface of the chassis.

Advantageously, the provision of a clamping arrangement which is slidably mounted to the chassis allows the centre of gravity of the clamping arrangement to shift as the blade tilts/rolls which helps to maintain more even loading on the transporter as the turbine blade rotates.

In the example illustrated in FIG. 3, the clamping arrangement is slidably mounted to the chassis so as to permit translation of the clamping arrangement along the first horizontal axis, i.e., longitudinally along a length of the chassis. Advantageously, permitting translation of the clamping arrangement along the first horizontal axis, i.e., longitudinally along a length of the chassis, allows the centre of gravity of the clamping arrangement to shift fore and aft to account for tilting of the blade during transportation.

However, it shall be appreciated that in other examples, the clamping arrangement may be slidably mounted to the chassis so as to permit translation of the clamping arrangement along the second horizontal axis, i.e., transversely across a width of the chassis. Advantageously, permitting translation of the clamping arrangement along the second horizontal axis, i.e., transversely across a width of the chassis, allows the centre of gravity of the clamping arrangement to shift left and right to account for rolling of the blade during transportation.

It shall also be appreciated that in some examples, the clamping arrangement may be allowed to translate in any direction along the horizontal plane defined by the upper surface of the chassis, or along both the first and second horizontal axes.

Examples of suitable slidable mountings which may be used to mount the clamping arrangement to the chassis including guideways, tracks, rails and rollers. It shall also be appreciated that in other examples, an alternative form of slidable mounting may be used.

In the example illustrated in FIG. 3, a guideway 28 is provided on the upper surface of the trailer 20. The guideway 28 is oriented in a direction parallel to the longitudinal axis of the trailer 20 and extends part way along the length of the chassis 22.

However, it shall be appreciated that in other examples, the clamping arrangement may be slidingly mounted to the chassis 20 to permit translation of the clamping arrangement along the second horizontal (Y) axis, i.e., transversely along a width of the chassis 22. In such examples, the guideway 28 may be oriented transversely across a width of the transporter if side to side movement (rather than fore and aft movement) is desired.

The guideway 28 illustrated in FIG. 3 is configured to receive a corresponding trolley 29 to which the clamping arrangement may be mounted.

The trolley 29 is provided which comprises a set of wheels 29a which are configured to be received within corresponding slots (not shown) which extend along the length of the guideway 28. This configuration enables the trolley 29 to translate along the length of the transporter 20, but substantially constrains movement of the trolley in any directions other than that which extends parallel to the longitudinal axis of the transporter.

In the example illustrated in FIG. 3, the slidably mounting is arranged to substantially prevent rotation of the clamping arrangement about the vertical (Z) axis. However, it shall be appreciated that in some examples, mountings which permit translation of the clamping arrangement along the first and/or second horizontal axes in addition to allowing rotation about the vertical (Z) axis may be envisaged.

As set out above, the rotatable or slidable mountings are designed to support a clamping arrangement configured to engage a portion of a turbine blade, proximal to the tip end of the turbine blade, and thereby secure it to the chassis of the transporter.

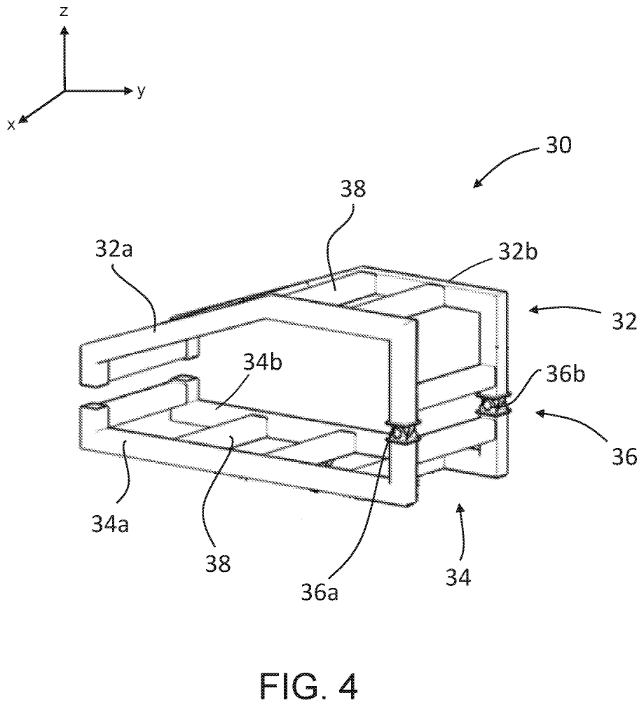

The clamping arrangement may be configured to engage a wind turbine blade across a chordwise portion of the blade. An example of a suitable clamping arrangement 30 is illustrated in FIG. 4.

The clamping arrangement 30 shown in FIG. 4 is provided in a clam-shell arrangement and is configured to engage a wind turbine blade across a chordwise portion of the blade. The clamping arrangement includes an upper portion 32, a lower portion 34 with a hinge 36 positioned therebetween to enable the upper portion 32 to pivot relative to the lower portion 44 between an open and closed position (the closed position being depicted in FIG. 4).

In the example illustrated in FIG. 4, the upper 32 and lower 34 portions are provided as a framework of elongate members with each portion comprising a pair of outer members 32a, b and 34a, b which define the periphery the upper 32 and lower 34 portions, and a series of cross members 38 which extend perpendicularly between the outer members 32a, b and 34a, b. In the example illustrated in FIG. 4, the outer members 32a and 34a are connected via a first hinge joint 36a and the outer members 32b and 34b are connected via a second hinge joint 36b which together form the hinge 36. However, it shall be appreciated that in other examples, other forms of clamping arrangement may be used.

An adjusting mechanism is provided to permit relative movement between the clamping arrangement and the chassis. The adjusting mechanism may be directly coupled between the clamping arrangement and the chassis or in some examples may be indirectly coupled between the clamping arrangement and the chassis.

The adjusting mechanism may be configured to allow the clamping arrangement to rotate relative to the chassis about the first and/or second horizontal axis.

The adjusting mechanism may be provided as a series of rotatable linkages, a series of rotatable mountings, a series of actuators or via a combination of the above.

Advantageously, the provision of an adjusting mechanism configured to permit movement of the clamping arrangement about a first and/or second horizontal axis allows the transporter to better account for bending or torsional loads which may be generated during transportation, and hence helps to prevent such loads from being applied onto the turbine blade.

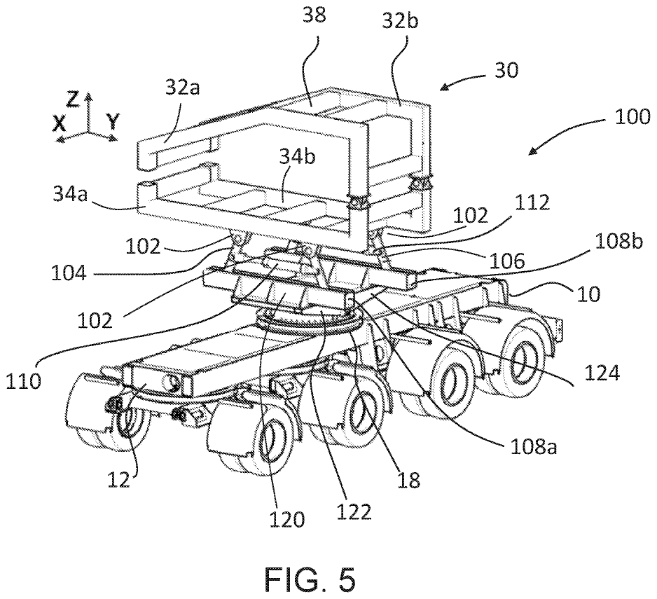

An example of one adjusting mechanism 100 according to the claimed invention is illustrated in FIG. 5.

The adjusting mechanism 100 illustrated in FIG. 5 is configured to permit rotation of the clamping arrangement 30 about both the first (X) and second (Y) horizontal axes. Furthermore, in the example illustrated in FIG. 5, the transporter is provided as a dolly trailer 10 having a rotatable mount 18 and so the clamping arrangement 30 is also able to rotate about the vertical (Z) axis relative to the trailer chassis 12.

However, it shall be appreciated that in other examples, the adjusting mechanism 100 may also be used with an extendable trailer 20, such as the one illustrated in FIG. 3. In such examples, rather than being rotatable about the vertical (Z) axis, the clamping arrangement 30 may instead be slidably mounted to the trailer 20 to enable the clamping arrangement 30 to translate in a horizontal plane relative to the chassis 22.

In the example illustrated in FIG. 5, the adjusting mechanism 100 is pivotably connected to an underside of the clamping arrangement 30 to permit rotation of the clamping arrangement 30 about the first horizontal (X) axis.

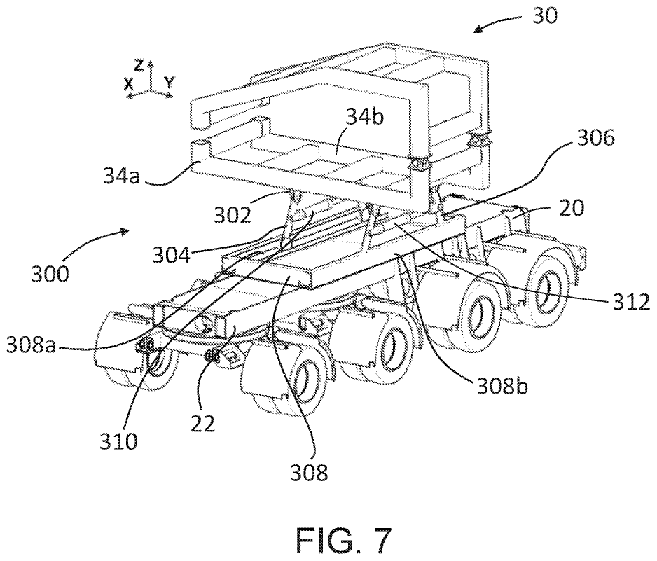

As set out above, this feature allows the clamping arrangement (and hence the turbine blade secured thereto) to roll to either side of the first horizontal axis. This helps to prevent torsional forces, which may be generated when travelling across banked or cambered terrain, from being applied onto the blade during transportation. However, it shall be appreciated that in other examples, such as the example illustrated in FIG. 7, the adjusting mechanism may be pivotably connected to an underside of the clamping arrangement 30 to permit rotation of the clamping arrangement 30 about the second horizontal (Y) axis. This feature allows the clamping arrangement (and hence the turbine blade secured thereto) to tilt about the second horizontal axis. This helps to prevent bending forces, which may be generated when travelling across inclined or declined terrain, from being applied onto the blade during transportation.

The adjusting mechanism 100 is pivotably connected to the clamping arrangement 30 by a series of ball joints linkages 102 which are located on the underside of the outer members 34a, b which form the clamping arrangement 30. However, it shall be appreciated that in other examples, other forms of suitable linkage may be used. In the example illustrated in FIG. 5, four ball joint linkages are provided (two on each member). However, it shall be appreciated that in other examples, a different number of linkages may be used.

A first pair of legs 104 may be pivotably connected to the clamping arrangement 30.

In some examples, such as that which is illustrated in FIG. 5, the first pair of legs may be pivotally connected to the clamping arrangement 30 via the ball joint linkages 102 provided on the underside of one of the outer members 34a. However, in other examples, a different form of connection may be used.

### A Second Pair of Legs 106 May Also Be Pivotably Connected to the Clamping Arrangement 30.

In some examples, the second pair of legs may be pivotally connected to the clamping arrangement 30 via the ball joint linkages 102 provided on the underside of the other outer member 34b, as shown in FIG. 5. However, in other examples, a different form of connection may be used.

The clamping arrangement may be pivotally connected to a first end of each leg. The second end of each leg may be received within a corresponding guideway. In some examples, the guideway may be provided as a pair of guideways.

In the example illustrated in FIG. 5, a pair of guideways 108a, 108b are provided which are oriented parallel to the second horizontal (Y) axis and hence extend transversely across a width of the chassis 12 of the transporter 10. The first pair of legs 104 are received within the first guideway 108a and the second pair of legs 106 are received within the second guideway 108b. The pair of guideways 108a, 108b are configured to permit translation of the legs along the length of each guideway and hence each leg can freely translate transversely across the width of the chassis 12. However, the orientation and configuration of each guideway substantially prevents movement of the legs along the first horizontal (X) axis (i.e., along the length of the chassis 12). Alternatively, in some examples, the guideway may be oriented along a longitudinal axis of the chassis to permit translation of the first and/or second pair of legs along a length of the chassis whilst substantially preventing translation of the first and/or second pair of legs across a width of the chassis, as illustrated in the example shown in FIG. 7 which will be described in greater detail later within this application.

Movement of the first and second pairs of legs along each of the of the respective guideways allows the relative height of the clamping arrangement 30 and chassis 12 to be adjusted as may be required to allow passage along roadways with limited vertical clearance. Notably, when the legs are oriented substantially perpendicularly to the guideway (i.e., when the legs are at their most upright) the height of the clamping arrangement relative to the chassis will be at a maximum.

However, as the second each of each leg is allowed to translate (or splay out) along each guideway away from their connection with the clamping arrangement 30, the legs will become oriented at shallower and shallower angles and hence the relative height of the clamping arrangement 30 will be reduced. As such, this arrangement allows for translation of the clamping arrangement along the vertical (Z) axis.

The adjusting mechanism may comprise one or more linear actuators configured for adjusting a height of the clamping arrangement relative to the chassis. This allows the adjusting mechanism to be actively controlled to alter the height of the clamping arrangement, which may be necessary to navigate along roadways with limited vertical clearance. The linear actuator may be provided in the form of one or more hydraulic actuators, or a different form of actuator may be used.

The one or more linear actuators may be oriented at an angle which is less than 45 degrees to the horizontal. Advantageously, by orienting the linear actuator(s) at a shallower angle, the adjusting mechanism is better able to make fine-level adjustments to the height of the clamping arrangement.

In some examples, a pair of first and second actuators 110, 112 may be arranged between each pair of legs 104, 106 to allow the height of the clamping arrangement 30 to be actively adjusted relative to the chassis 12.

As is illustrated in FIG. 5, the first actuator 110 may be arranged between the first pair of legs 104 and the second actuator 112 may be arranged between the second pair of legs 106. As such, the first actuator 110 may be configured for adjusting a height of one of the outer members 34a (i.e., a first portion) of the clamping arrangement 30 relative to the chassis 12 and the second actuator 112 may be configured for adjusting a height of the other outer member 34b (i.e., a second portion) of the clamping arrangement 30 relative to the chassis 12.

In some examples, the first actuator 110 may be oriented substantially parallel to the second horizontal (Y) axis and may extend transversely across the width of the chassis 12, as shown in FIG. 5. Similarly, the second actuator 112 may also be oriented substantially parallel to the second horizontal (Y) axis and may extend transversely across the width of the chassis 12. However, in other examples, the angle formed between the first and/or second actuator and the first or second horizontal axis may fall between 0 and 45 degrees. It shall also be appreciated that in some examples, such as the example illustrated in FIG. 7, the first and second actuators may also be oriented substantially parallel to the first horizontal (X) axis and hence may extend longitudinally along a length of the chassis 12.

In the example illustrated in FIG. 5, the first 110 and second 112 actuators are provided in the form of first and second hydraulic cylinders, although it shall be appreciated that in other examples alternative types of actuators may be used.

In examples wherein the first and/or second actuators are hydraulic actuators (such as the example illustrated in FIG. 5), in order to reduce the height of the clamping arrangement 30 (i.e., to reduce the distance between the clamping arrangement 30 and the chassis 12) pressurised fluid is introduced into the cylinder of each actuator. This will cause the pressure within the cylinder to increase which will in turn act on the piston and cause it to extend.

In the example illustrated in FIG. 5, the first 110 and second actuators 112 are coupled to the first 104 and second 106 pairs of legs. Notably, a first end of each actuator is coupled to one of the legs received within each guideway 108a, b, and the second end of each actuator is coupled to the other legs received in each guideway 108a, b. As such, as the stroke of the piston increases, the respective legs are pushed outwardly along the length of the guideway 108a, 108b thereby causing the angle of each leg to shallow which in turn lowers the clamping arrangement 30.

Conversely, the height of the clamping arrangement 30 can also be increased back to its maximum height (in the case of FIG. 5 wherein the legs 104, 106 are oriented substantially perpendicularly to the guideway 108) via relieving pressurised fluid from each cylinder which will cause the piston to retract thereby steepening the angle of the legs 104, 106 supporting the clamping arrangement which in turn increases the height of the clamping arrangement (i.e., increases the distance between the clamping arrangement 30 and the chassis 12).

In the example illustrated in FIG. 5, the first and second hydraulic are unconnected and hence both actuators are independently controllable via a controller or the like. However, it shall be appreciated that in some examples, the first and second hydraulic cylinders may be provided in fluid communication with one another, via a hose or other suitable fluid-tight connection.

The adjusting mechanism may also comprise a swing frame which is configured to permit rotation of the clamping arrangement about the second horizontal (Y) axis (as shown in FIG. 5). This feature enables the adjusting mechanism to account for tilt which may be encountered when travelling along inclined or declined roadways which, if left unaccounted for, can cause bending stresses to be exerted in the blade. However, it shall be appreciated that in other examples, the swing frame may be configured to permit rotation of the clamping arrangement about the first horizontal (X) axis. This feature enables the adjusting mechanism to account for roll which may be encountered when travelling along banked or cambered roadways which, if left unaccounted for, can cause torsional stresses to be exerted in the blade.

In the example illustrated in FIG. 5, the swing frame 120 is approximately V-shaped and comprises a pair of arms 122,124 which each support one of the respective guideways 108a, b. The apex of the swing frame 120 is mounted to the rotatable mount 18 via a support pin (or other suitable means) which extends transversely across the width of the chassis (parallel to the second horizontal (Y) axis) and thereby allows the swing frame 120 to rock (or rotate) about the second horizontal (Y) axis.

However, it shall be appreciated that in examples wherein the first and second actuators are fluidly connected (which causes the stroke of one actuator to lengthen as the other is shortened), rotation of the clamping arrangement 30 about the first (X) or second horizontal (Y) axis may be provided by the legs and actuator arrangement only and hence, in such examples, the swing frame 120 may be omitted. However, in order to provide height adjustment in systems with connected hydraulic actuators, the hydraulic cylinders will need to be placed in a neutral position and more fluid will need to be introduced into the system. As such, whilst height adjustment in such systems is still possible, it is less practical compared to systems wherein the actuators are not fluidly connected.

It shall also be appreciated that whilst FIG. 5 has been described in relation to an image in which the rotatable mount is at a substantially neutral (0 degree) position about the vertical (Z) axis, it shall be appreciated that in instances where the rotatable mount is at a 90 degree or 270 degree position, the first (X) and second (Y) horizontal axis will be flipped and hence the first (X) horizontal axis will extend transversely across the width of the chassis and the second (Y) horizontal axis will extend longitudinally along the length of the chassis.

The example illustrated in FIG. 5 advantageously provides an adjusting mechanism which enables the height and orientation of the tip end of a wind turbine blade to be more actively controlled and better allows for fine-level adjustments of the height of the clamping arrangement during use.

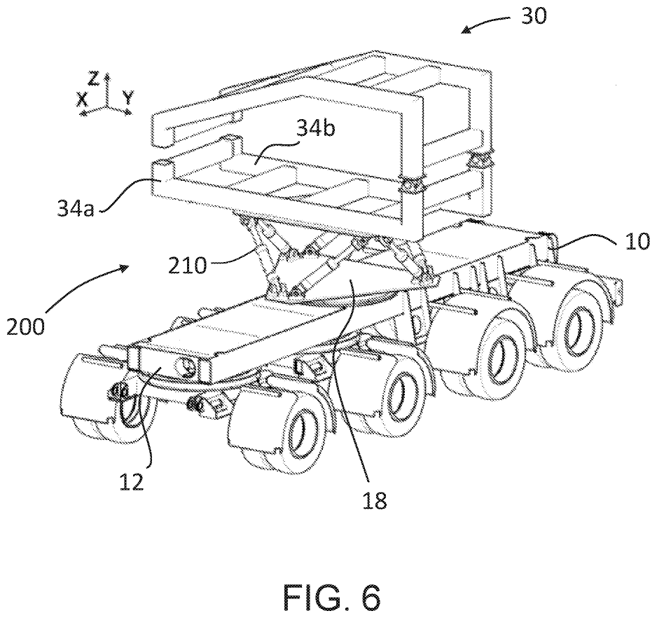

An example of another adjusting mechanism 200 according to the claimed invention is illustrated in FIG. 6.

The adjusting mechanism 200 illustrated in FIG. 6 is also configured to permit rotation of the clamping arrangement 30 about both the first (X) and second (Y) horizontal axes. As with FIG. 5, in the example illustrated in FIG. 6, the transporter is provided as a dolly trailer 10 having a rotatable mount 18 and so the clamping arrangement 30 is also able to rotate about the vertical (Z) axis relative to the trailer chassis 12.

However, it shall be appreciated that in other examples, the adjusting mechanism 200 may also be used with an extendable trailer 20, such as the one illustrated in FIG. 3. In such examples, rather than being rotatable about the vertical (Z) axis, the clamping arrangement 30 may instead be slidably mounted to the transporter to enable the clamping arrangement 30 to translate in a horizontal plane relative to the chassis 22.

The adjusting mechanism 200 comprises a plurality of linear actuators 210 which are arranged to permit rotation of the clamping arrangement 30 about the first (X) and second (Y) horizontal axes and also to allow for translation of the clamping arrangement 30 along the vertical (Z) axis relative to the chassis 12. This enables the adjusting mechanism 200 to account for bending or torsional forces which may be applied to the blade whilst travelling across inclined or banked terrain and enables the adjusting mechanism 200 to alter the height of the clamping arrangement 30 which can be useful when travelling along roadways with limited vertical clearance.

The linear actuators 210 may be directly connected to the clamping arrangement. In other words, in some examples the forces generated by the linear actuators may be applied directly to the clamping arrangement rather than via a series of linkages. In the example illustrated in FIG. 6, the linear actuators are secured at one end to the rotational table 18 and at their other end are rotatably connected to an underside of the clamping arrangement 30 via a ball joint or other suitable connector. However, in other examples (such as those illustrates in FIGS. 5 and 7), the linear actuators may be indirectly coupled to the clamping arrangement.

In the example illustrated in FIG. 6, the linear actuators are provided as a hexapod of six hydraulic cylinders. Three linear actuators are arranged between the rotational table 18 and the underside of the first outer member 34a of the clamping arrangement 30 and three linear actuators are arranged between the rotatable mount 18 and the underside of the second outer member 34b of the clamping arrangement 30. However, it shall be appreciated that in other examples, a different number of actuators may be used provided that at least one actuator is connected to the clamping arrangement on either side of its axis of rotation about both the first (X) and second (Y) horizontal axes.

The plurality of linear actuators may be oriented at an angle of approximately 45 degrees to the horizontal, as is shown in FIG. 6. However, it shall be appreciated that in other examples, the plurality of linear actuators may be provided at shallower angles (i.e., between 0 degrees and 45 degrees) to provide for finer-level adjustments to the orientation and height of the clamping arrangement.

As has been described above in relation to FIG. 5, the stroke of the respective pistons of the plurality of linear actuators can be adjusted to alter a respective height of a portion of the clamping arrangement to which the linear actuator is attached. As such, by actively controlling the stroke of each hydraulic actuator via a controller or other suitable means, the adjusting mechanism 200 can alter the vertical position of different portions of the clamping arrangement 30 thereby enabling the clamping arrangement 30 to be rotated about the first (X) and (Y) horizontal axes and allowing the height of the clamping arrangement 30 to be adjusted.

For example, to allow for rotation about the first horizontal (X) axis, the linear actuators which are connected to the clamping arrangement (30) on one side of its axis of rotation may be extended whereas those connected on the other side of its axis of rotation may be retracted thereby causing the clamping arrangement to roll. Similarly, to allow for rotation about the second horizontal (Y) axis, the linear actuators which are connected to the clamping arrangement 30 fore of its axis of rotation may be extended whereas those connected aft of its axis of rotation may be retracted thereby causing the clamping arrangement to tilt. Furthermore, each of the linear actuators may be extended or retracted in unison thereby allowing for the height of the clamping arrangement 30 to be raised or lowered.

The example illustrated in FIG. 6 advantageously provides an adjusting mechanism which is highly controllable, and which allows the clamping arrangement to be oriented in a vast number of different orientations. As such, the amount of torsional stress which is exerted on a wind turbine blade supported on a such an arrangement is practically nil.

Finally, an example of another adjusting mechanism 300 according to the claimed invention is illustrated in FIG. 7.

As with the mechanisms illustrated in FIGS. 5 and 6, the adjusting mechanism 300 illustrated in FIG. 7 is configured to permit rotation of the clamping arrangement 30 about both the first (X) and second (Y) horizontal axes.

In the example illustrated in FIG. 7, the transporter is provided as an extendable trailer 20 and hence the clamping arrangement 30 is slidably mounted to the trailer 20 to enable the clamping arrangement 30 to translate relative to the chassis 22 along the first horizontal (X) axis. However, it shall be appreciated that in other examples the clamping arrangement 30 may be slidably mounted to the trailer 20 to permit translation of the clamping arrangement 30 along the second horizontal (Y) axis or that the adjusting mechanism 300 may be used with a dolly trailer 10 having a rotatable mount 18, thereby enabling the clamping arrangement 30 to rotate about the vertical (Z) axis relative to the trailer chassis 12.

As with the example illustrated in FIG. 5, in the example illustrated in FIG. 7, the adjusting mechanism 300 is pivotably connected to an underside of the clamping arrangement 30 by a series of ball joints linkages 302 which are located on the underside of the outer members 34a, b which form the clamping arrangement 30. However, in the example illustrated in FIG. 7 the ball joint linkages 302 are oriented so as to permit rotation of the clamping arrangement 30 about the second horizontal (Y) axis, which extends transversely across the width of the chassis, rather than the first horizontal (X) axis as is the case with the example illustrated in FIG. 5.

In FIG. 7, the outer members 34a, b of the clamping arrangement 30 are each provided with two ball joint linkages 302 which are each provided at corresponding positions on the underside of each member 34a, b. Two pairs of legs 304, 306 are pivotably connected to the clamping arrangement 30 via the ball joint linkages 302, with each pair of legs 304, 306 having one leg connected to a ball joint linkage 302 on the foremost outer member 34a and another leg connected to a ball joint linkage 302 on the aftmost outer member 34b. The ball joint linkages 302 are coupled to a first end of each leg, proximal to the clamping arrangement 30, with the second end of each leg being received within a corresponding guideway 308.

A pair of guideways 308a, 308b are provided which are oriented parallel to the first horizontal (X) axis and hence extend longitudinally along a length of the chassis 22 of the transporter 10, rather than transversely across the width of the chassis as is the case in the example shown in FIG. 5.

The first pair of legs 304 are received within the first guideway 308a which is located on one side of the chassis 22 (in this case the left-hand side) and the second legs are received in the second guideway 308b which is located on the other side of the chassis 22 (in this case the right-hand side). The pair of guideways 308a, 308b are configured to permit translation of the legs along the length of each guideway and hence each leg can freely translate longitudinally along the length of the chassis 22. However, the orientation and configuration of each guideway substantially prevents movement of the legs along the second horizontal (Y) axis (i.e., across the width of the chassis 22).

As with the example shown in FIG. 5, a pair of first and second actuators 310, 312 are arranged between each pair of legs 304, 306. The first actuator 310 is arranged between the first pair of legs 304 and the second actuator 312 is arranged between the second pair of legs 306. In the example illustrated in FIG. 7, the first 310 and second 312 actuators are provided in the form of first and second hydraulic cylinders, although it shall be appreciated that in other examples alternative types of actuators may be used.

However, unlike the example illustrated in FIG. 5, in the example illustrated in FIG. 7, the first actuator 310 is oriented substantially parallel to the first horizontal (X) axis and extends longitudinally along one side of the chassis 22. As such, the first actuator 310 is oriented at an angle of less than 45 degrees to the horizontal. Similarly, the second actuator 312 is also oriented substantially parallel to the first horizontal (X) axis, extending longitudinally along the other side of the chassis 22, and is therefore also oriented at an angle of less than 45 degrees to the horizontal.

The first actuator 310 is configured for adjusting a height of one a first side (in this case the left-hand side) of the clamping arrangement 30 relative to the chassis 22 and the second actuator 312 is configured for adjusting a height of the other side of the clamping arrangement 30 (in this case the right-hand side) relative to the chassis 22.

As has been described in relation to FIG. 5, each end of the first 310 and second 312 actuators is connected to a respective leg. In the example shown in FIG. 7, one end of the first actuator 310 is connected to the leg connected to the foremost member 34a on the left-hand side of the chassis 22 and the other end is connected to the leg connected to the aftmost member 34b on the left-hand side of the chassis 22. Similarly, one end of the second actuator 312 is connected to the leg connected to the foremost member 34a on the right-hand side of the chassis 22 and the other end is connected to the leg connected to the aftmost member 34b on the right-hand side of the chassis 22.

When the legs 304, 306 are oriented substantially perpendicularly to the guideway (i.e., when the legs are at their most upright) the height of the clamping arrangement 30 relative to the chassis 22 will be at a maximum. However, as the stoke length of the first 310 or second 312 actuators is increased, a force will be applied to each of the legs connected to said actuator causing them to translate (or splay out) along their respective guideway 308 away from the ball joint linkage 302 which connects the clamping arrangement 30 to each leg. As such, as the stroke of the actuator increases, the respective legs 304, 306 are pushed along the length of the guideway 308a, 308b thereby causing the angle of each leg 304, 306 to shallow which causes the relative height of the clamping arrangement 30 proximal to each leg 306,308 to be reduced as the stroke length of the actuator 310, 312 increases.

In the example illustrated in FIG. 7, the first and second hydraulic cylinders are fluidly connected via a hose or other suitable means. As such, when fluid is allowed to flow into the cylinder of one of the actuators (to increase the stroke of the piston and hence lower one side of the clamping arrangement) the amount of fluid present in the cylinder of the other actuator will be reduced thereby causing the piston of the other actuator to retract. As such, when one of the first or second actuators is activated (and its stroke length increased) the clamping arrangement 30 will become tilted towards that side. Therefore, the actuation of the first and second hydraulic cylinders can be controlled by a controller or other suitable means to cause the clamping arrangement 30 to rotate about the first horizontal (X) axis.

The adjustment mechanism 300 illustrated in FIG. 7 can therefore account for the banking angle of the terrain over which the transporter is travelling, thereby helping to prevent torsional (or twisting) loads from being applied to the blade. Furthermore, the adjustment mechanism 300 has fewer components when compared to those illustrated in FIGS. 5 and 6 and so also provides the end user with a more compact adjusting mechanism.

As mentioned previously, in examples wherein the first and second actuators are fluidly connected (which causes the stroke of one actuator to lengthen as the other is shortened), the clamping arrangement may also be translated along the vertical (Z) axis (in order to increase or reduce the distance between the clamping arrangement 30 and the chassis) via introducing or removing fluid from the hydraulic cylinders of the respective actuators and so height adjustment can also be achieved when using adjusting mechanism according to such examples.

Although the invention has been described above with reference to one or more preferred examples, it will be appreciated that various changes or modifications may be made without departing from the scope of the invention as defined in the appended claims.

1. A ground transporter for supporting a tip end of a wind turbine blade, the transporter comprising:
a chassis having at least one ground contacting element;
a clamping arrangement configured for securing a tip end of a wind turbine blade to the chassis; and
an adjusting mechanism configured to permit movement of the clamping arrangement relative to the chassis,
wherein the adjusting mechanism is configured to allow the clamping arrangement to rotate about at least one horizontal axis.

2. The transporter according to claim 1, wherein the clamping arrangement is rotatably mounted to the chassis to allow the clamping arrangement to rotate about a vertical (Z) axis relative to the chassis, and preferably wherein the clamping arrangement is mounted to the chassis via a rotational table.

3. The transporter according to claim 1, wherein the adjusting mechanism is pivotably connected to the clamping arrangement so as to permit rotation of the clamping arrangement about the at least one horizontal axis.

4. The transporter according to claim 1, wherein the adjusting mechanism comprises a first linear actuator configured for adjusting a height of a first portion of the clamping arrangement relative to the chassis, and wherein the first linear actuator is orientated at an angle less than 45 degrees to the horizontal.

5. The transporter according to claim 4, wherein the adjusting mechanism comprises a first pair of legs which are pivotably connected to the clamping arrangement and wherein the first linear actuator is arranged between the first pair of legs.

6. The transporter according to claim 4, wherein the adjusting mechanism comprises a second linear actuator configured for adjusting a height of a second portion of the clamping arrangement relative to the chassis, and wherein the second linear actuator is orientated at an angle less than 45 degrees to the horizontal.

7. The transporter according to claim 6, wherein the adjusting mechanism comprises a second pair of legs which are pivotably connected to the clamping arrangement, and wherein the second linear actuator is arranged between the second pair of legs.

8. The transporter according to claim 6, wherein the first and second linear actuators comprise hydraulic cylinders, and wherein the first and second hydraulic cylinders are connected in fluid communication with each other.

9. The transporter according to claim 7, wherein the first and/or second pair of legs are configured to engage with a corresponding guideway, and wherein the guideway is oriented along a longitudinal axis of the chassis so as to permit translation of first and/or second pair of legs along a length of the chassis.

10. The transporter according to claim 7, wherein the first and/or second pair of legs are configured to engage with a corresponding guideway, and wherein the guideway is oriented along a transverse axis of the chassis so as to permit translation of the first and/or second pair of legs across a width of the chassis.

11. The transporter according to claim 1, wherein the adjusting mechanism is configured to allow the clamping arrangement to rotate about a first horizontal axis and a second horizontal axis relative to the chassis, wherein the second horizontal axis is perpendicular to the first horizontal axis.

12. The transporter according to claim 1, wherein the adjusting mechanism comprises a swing frame configured to permit rotation of the clamping arrangement about the first or second horizontal axis.

13. The transporter according to claim 11, wherein the adjusting mechanism comprises a plurality of linear actuators configured to permit vertical translation of the clamping arrangement relative to the chassis and configured to permit rotation of the clamping arrangement about the first and second horizontal axes relative to the chassis.

14. The transporter according to claim 13, wherein each of the linear actuators are orientated at an angle less than 45 degrees to the horizontal.

15. The transporter according to claim 1, wherein the clamping arrangement is configured to engage the wind turbine blade across a chordwise portion of the wind turbine blade, and preferably wherein the clamping arrangement comprises a clam-shell arrangement having an upper portion, a lower portion and a hinge connecting the upper and lower portions so as to allow the upper portion to pivot relative to the lower portion between an open and a closed position.

16. The transporter according to claim 1, wherein the transporter is a dolly trailer.

17. The transporter according to claim 1, wherein the clamping arrangement is fixed to the chassis to substantially prevent translation of the clamping arrangement along a horizontal plane of the chassis.

18. The transporter according to claim 1, wherein the transporter is an extendable trailer.

19. The transporter according to claim 1, wherein the clamping arrangement is slidably mounted to the chassis to permit translation of the clamping arrangement along a horizontal plane of the chassis.

20. The transporter according to claim 1, wherein the clamping arrangement is slidably mounted to the chassis to permit translation of the clamping arrangement along a length of the chassis.
